(19) United States
(12) Patent Application Publication
(10) Pub. No.: US 2008/0298858 A1
(43) Pub. Date: Dec. 4, 2008

(54) Automation mechanism for positioning transfer dicorotron cover or shutter

(75) Inventors: Edward W. Schnepf, Ontario, NY (US); Bruce J. Parks, Bloomfield, NY (US); James J. Spence, Honeoye Falls, NY (US)

Correspondence Address: JAMES J. RALABATE, 5792 MAIN ST., WILLIAMSVILLE, NY, 14221, US

(73) Assignee: Xerox Corporation

(21) Appl. No.: 11/810,082

(22) Filed: Jun. 4, 2007

(51) Int. Cl. G03G 15/16

(52) U.S. Cl. 399/311

(57) ABSTRACT

This is a structure useful in electrostatic marking systems that prevents a charge from contacting a photoreceptor in areas not covered by paper. An automatically movable cover is positioned between a corona device and the photoreceptor to prevent the charge emitted by the corona from damaging the unprotected areas of the photoreceptor. The movement and positioning of the shutter or cover is automatically calibrated by the width of paper being used. Since a plurality of paper widths can be used in an electrostatic marking system, various portions of the photoreceptor will be exposed. The entire determination to move the cover or shutter and to the extent positioned is automatically determined minimizing the possibility of error if manual positioning of the cover was used.

This invention relates to electrostatic marking systems and, more specifically, to the transfer station of said systems.

### BACKGROUND

Electrostatography is best exemplified by the process of Xerography as first described in U.S. Pat. No. 2,297,691 to C. F. Carlson. In this process, the photoconductor is first provided with a uniform electrostatic charge over its surface and is then exposed to imagewise activating electromagnetic radiation which selectively dissipates the charge in illuminated areas of the photoconductor while the charge in the non-illuminated areas is retained thereby forming a latent electrostatic image. This latent electrostatic image is then developed or made visible by the deposition of finely-divided electroscopic marking particles referred to in the art as “toner”. The toner will normally be attracted to those areas of the layer which retain a charge, thereby forming a toner image corresponding to the latent electrostatic image. This powder image may then be transferred to a support surface such as paper. The transferred image may subsequently be permanently affixed to the support by heat fusing. Instead of forming a latent image by uniformly charging the photoconductive layer and then exposing the layer to a light and shadow image, a latent image may be formed by charging an insulating or photoconductive insulating member in image configuration. The powder image may be fixed to the imaging member if elimination of the powder image transfer step is desired.

Several methods are known for applying an electrostatic charge to the photosensitive member such as the use of electron-emitting pins, an electron-emitting grid, single corona-charging structures and multiple dicorotron wire assemblies. In recent development of high speed Xerographic reproduction machines where printers can produce at a rate of or in excess of three thousand prints per hour, the need for several reliable dicorotron wire assemblies in order to utilize the full capabilities of the reproduction system is required. Also, with the advent of color printers where several corona-charging stations are needed, the requirement for dependable photoconductor surfaces and dicorotron wire assemblies for depositing an electrostatic charge is essential.

Generally, in electrostatographic or electrostatic marking processes, a number of corotrons or dicorotrons are used at various stations around the photoreceptor. For example, the dicorotrons are used at the changing station where a uniform charge is applied to the photoreceptor, at a transfer station, and at a cleaning station, etc. In today's high speed printers, it is important that all corotrons (or dicorotrons) are in perfect working order since corotron malfunction can easily render the entire printing process useless. Some high speed printers, including color printers, use several dicorotron units, as many as sixteen corotron or dicorotron units are used. Maintaining each corotron unit and the photoreceptor belt or drum in perfect working order is essential to the proper functioning of these complex fast color printers. In some cases, it is common to use one or several wire containing corona-generating device(s) (“corotron” or “dicorotron”) for depositing the electrostatic charge at the above-noted stations. The wire or corona-generating electrode is typically a highly conductive elongated wire situated in close proximity to the photoconductive surface or paper to be charged. Since, in a dicorotron, the wire electrode is comprised of a thin outer glass brittle coating, it may be easily damaged. Some manual adjusting, handling or cleaning of this electrode often results in fracture of the glass coating which could damage or destroy the corona. The corotrons used in embodiments of this invention can have any suitable configuration.

During the extended runs of printing in Xerographic systems on paper stock width less than the maximum width, in one embodiment a portion of the inboard end of the photoreceptor layer is exposed to transfer corona charging, a charging that is intended for the back side of the paper. This disrupts the electrostatic properties in this end area of the photoreceptor (PR) or photoconductive layer. The corona is intended to transfer the toned image from the photoreceptor to the paper but, because of various size (width) paper, some of the charge emitted from the corona hits the exposed end or other exposed portions of the photoreceptor (PR) surface that is not covered by the paper. There are blocking means that are manually used to cover this end portion of the PR but adjustment is cumbersome and requires manual adjustment each time a different width paper is used. Especially in high speed marking systems, shutting down the system to manually adjust this blocking cover each time a paper is changed is time consuming, sometimes imprecise, and frustrating to the customer or machine operator.

The electrostatic properties of the PR that is exposed to transfer corona charge eventually become modified, resulting in inferior prints and premature PR replacement. There is a need in today's high speed and color electrostatic marking systems for a precise and fully automatic system for positioning a blocking cover or shutter.

A problem of concern and attended to in the present embodiments has to do with the way the photoreceptor (PR) is designed and its susceptibility to trapping positive charges in one of its layers during extended exposure to positive or other current from the transfer corotron. These trapped positive charges then change the behavior of the PR during subsequent charging, exposing, and developing steps as compared to the PR areas that are covered or protected by paper. This does not become apparent until the customer changes to a paper size and image that overlaps both damaged and protected PR areas. Because of these damaged exposed portions, the developed image will appear slightly different in each part of the PR.

### SUMMARY

This invention provides the use of an automatically adjustable and movable cover or shutter that would act as a shield between the transfer corona device and the photoreceptor surface to prevent positive charging of the unprotected photoreceptor surface. The cover or shutter would automatically be positioned and the amount of travel would be based upon the paper size programmed for the particular job.

In some electrostatic marking systems, a stock library is sometimes located in each machine. This library contains various parameters of the system and frequently comprises a controller. This controller can be programmed so that when the width of the paper to be used is set, it will automatically adjust the corona end cover to the appropriate width coinciding with the paper width. This controller would automatically slide the cover or shutter to the proper position so that no end or other portion of the PR will be exposed to corona charging. Defects caused in the prior art by manual adjustment resulting in a corona-damaged PR will thereby be prevented or at least minimized. Various suitable operable ways can be used to connect the controller to the transfer corona device cover.

In one embodiment where all paper sizes are registered to a common outboard datum and the inboard edge location changes as the paper width changes there would be a sliding feature between the transfer and detack dicorotrons that would engage both the inboard cover and a paper width adjust rack. The sliding feature would also be spring loaded towards the outboard and would only move back and forth the distance required by the shutter or cover. The rack would contact the feature as it slides inboard and move the cover to the proper paper width corresponding to the rack. The positioning of the shutter or rack is automatically controlled via software in the paper stock library. The stock library contains in some machines entries of media being used in this machine. Each entry contains all the characteristics of that paper, such as length, width, weight and coated or not coated paper. The desired entry in the stock library for a certain paper is assigned to the feed tray to be used. It is the width information that tells the rack in the transfer mechanism to move towards the inboard to the proper position during machine cycle up and printing. The position of the rack, in turn, would position the inboard cover.

In an embodiment of the present invention, a linkage mechanism is used that would link to the paper width adjustment rack. In this one embodiment the rack runs inboard/outboard and is driven by a stepper motor having a rack positioned sensor. The mechanism would automatically move the transfer inboard (or outboard) cover to the proper position in parallel with the width rack. The sensor can be placed to act as a home sensor where it detects the rack in the fully inboard position, called the home position. In the home position, the shutter or cover is not shielding the photoreceptor. To position the shutter for a particular paper size, an algorithm is used to calculate the correct number of motor steps for the amount of movement to place the shutter tip at the inboard edge of the programmed paper size.

Additional shutter drive options that are included within the scope of this invention are:
A. Shutter arm is mounted to a carriage that slides along a linear track. The carriage would be connected to a capstan drive tape. The carriage would park in home position as described above.
B. Shutter arm is mounted to a carriage that slides along a linear track. The carriage would be connected to a linear actuator drive. The carriage would park in home position as described above.
C. Instead of a home sensor, use a motor shaft position sensor to count the rotations of the shaft to determine shutter position.
D. Use a servo motor that doesn't require an independent home sensor.

As earlier noted, during the image transfer process, the region of the photoreceptor surface that is not covered by papers is exposed to a high level of positive charging that can eventually lead to non-uniform image quality due to trapped positive charges. The problem presents itself after a number of sheets of the same size are run followed by the customer changing to a different size sheet that has image in both the prior bare PR belt region and protected region. The image in the prior bare belt region is darker in density than the image in the prior protected region. This artifact has been called “Paper Edge Ghost” due to the distinct image density shift observed at the boundary between the two regions.

When a controller or stock library is used, the desired entry in the stock library for a certain paper is assigned to the feed tray to be used. It is the width information that tells the adjuster to move towards the inboard (or in come cases outboard) to the proper position during machine cycle up and printing. The position of the adjuster, in turn, would position the inboard cover or shutter. When the term “portions not covered by the paper” or “exposed portions” are used in reference to the photoreceptor surface, it is intended that this portion of said surface include inboard or outboard parts of said surface.

The inboard corona used in some specific embodiments of this invention comprise an elongated modified U-shaped housing containing along its length a corona or electrode wire connected and strung at each end by insulator anchors. The electrode wire emits an electric charge to the back of an image receiving sheet to cause transfer of the toned image from the PR to the receiving sheet, usually paper. The automated cover has a modified inverted U-shaped configuration which movably fits into the modified U-shaped housing and is connected to an adjuster which, together with a controller, automatically moves the cover to the precise location to block charge emissions from the wire (or pins) to any part of the PR. The charge, because of the cover, is directed only to the back of the receiving sheet. A controller earlier described will instruct the adjuster to accommodate the desired paper width so that no charge is placed upon the uncovered PR exposed portion(s). Thus, the controller receives information on the paper width to be used. The controller automatically instructs the adjuster as to the precise equalized movement of the cover and the adjuster moves the cover as instructed, depending on the width of the paper used in this marking or imaging run.

The cover or shutter is comprised of any suitable electrically insulating material that will not permit the passage of an electric charge there through and does not inhibit charging capabilities. The cover or shutter is configured so that it will easily slide back and forth in the housing and over the charge-emitting wire (or pins) when the adjuster or adjuster rack moves the shutter or cover. The shutter is profiled to conform radially (in one embodiment) around the transfer corona device and not permit current to escape beyond its edges. The shutter or cover will be guided to control spatial constraints between the PR and transfer corona device by utilizing suitable devices. Further specifics of embodiments will be provided by the drawings and their description.

Embodiments of this invention provide a mechanism to automatically move the inboard or outboard corotron cover in the proper position for the associated paper width used in the electrostatic marking system. This avoids the photoreceptor from being exposed to transfer corona in the area where there is no paper, thus protecting the uncovered areas of the PR. An intent of these embodiments is to avoid operator error by doing the adjustment precisely and automatically. By “exposed portions” of said photoconductive PR surface as used throughout the disclosure and claims is meant that part of this PR surface not covered or protected by a sheet. FIG. 4 and its description clearly shows and defines “exposed portions”.

### BRIEF DESCRIPTION OF THE DRAWINGS

FIG. 1 illustrates a portion of the relevant parts of the transfer station of an electrostatic marking system as it relates to embodiments of this invention.

FIG. 2A illustrates an embodiment of the corona unit with the movable automatically adjustable cover and adjustment rack. FIG. 2B is a front view of 2A.

FIG. 3 illustrates a top view of an embodiment of this invention.

FIG. 4 illustrates a simplified side view of an embodiment illustrating the use of a shutter in the unit herein disclosed.

### DETAILED DISCUSSION OF DRAWINGS AND PREFERRED EMBODIMENTS

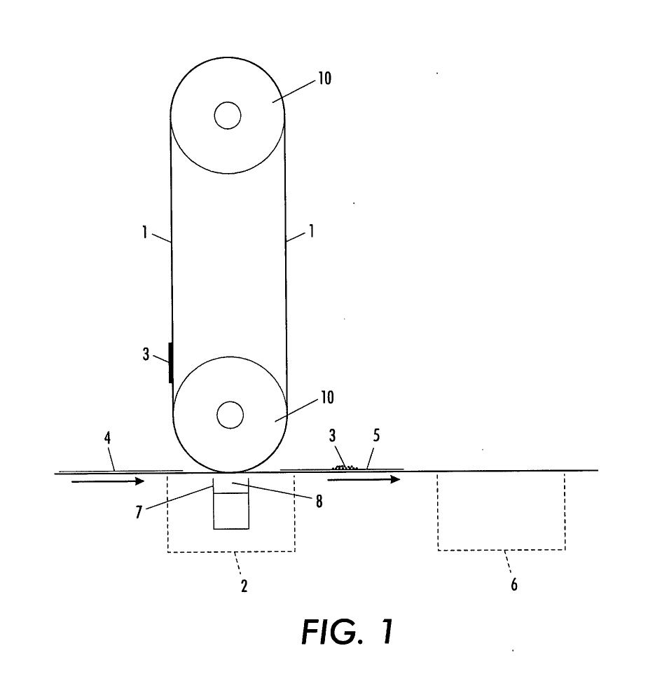

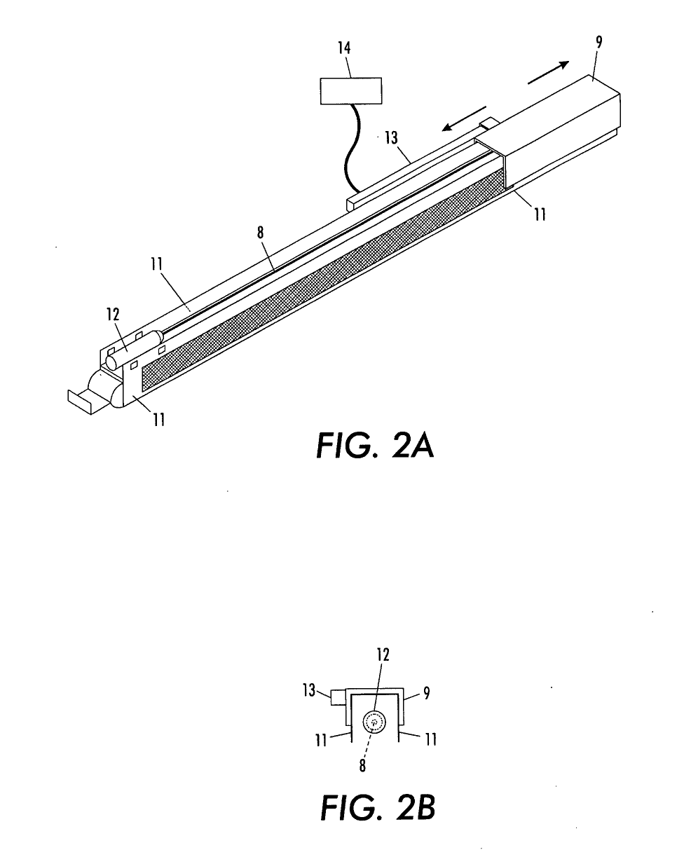

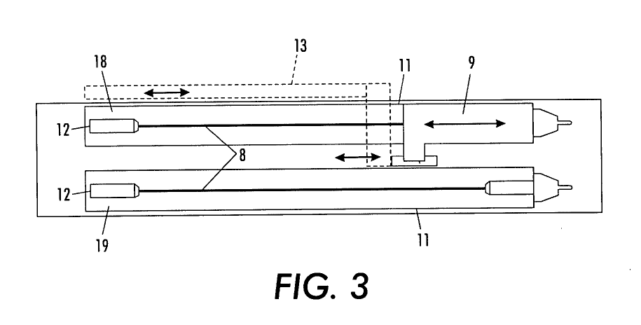

In FIG. 1, an endless photoreceptor belt 1 is shown as it passed through a transfer station 2 of an electrostatic marking system. In this transfer station 2, a toned image 3 on belt 1 is transferred to a paper-receiving sheet 4 so that sheet 4 now has the image 3 on its surface as toned sheet 5 now proceeds to a fusing station 6. The image 3 is transferred to the sheet 4 by the use of a corona or dicorotron unit 7 wherein corona wire 8 (or in some cases, pins) emits a charge to cause this transfer. The cover or shutter 9 used in embodiments is not shown but is clearly shown and defined in relation to FIGS. 2 and 3. In this embodiment a photoreceptor belt 1 continuously rotates over rollers 10 during the marking process. Obviously, other suitable photoreceptive configurations other than belts may be used such as drums.

In FIGS. 2A and 2B and FIG. 3, an automatically adjustable cover or shutter 9 is shown as it movably fits over (or optionally into) the dicorotron housing 11.

FIG. 3 depicts a top view of two dicorotrons, an upper dicorotron 18 which shows the location of a cover or shutter 9 and a lower conventional dicorotron 19 absent any shutter or cover 9. The shutter or cover 9 can be easily retrofitted onto the conventional dicorotron 19 if and when desired.

The transfer corotron or dicorotron comprises a housing 11, a corona wire 8 strung across the length of housing 11 and wire anchors 12 located at both ends of housing 11. Cover or shutter 9 is slidably fit over housing 11 and operatively connected to an adjusting rack 13 which automatically moves cover or shutter 9 to the correct location as instructed by controller 14. Controller 14 will match the paper width precisely to the wire 8 distance that conforms to the unprotected PR as determined by the paper width. In this way, only the paper 4 is exposed to charge while the shutter or cover 9 protects the portion of the photoreceptor not covered with paper. This automatic movement of shutter or cover 9 to conform to the paper width and uncovered PR is an extremely important feature of the present embodiments. Any suitable moving means may be connected to the adjusting rack 13 such as a stepper motor with a rack positioned sensor (not shown in the drawings).

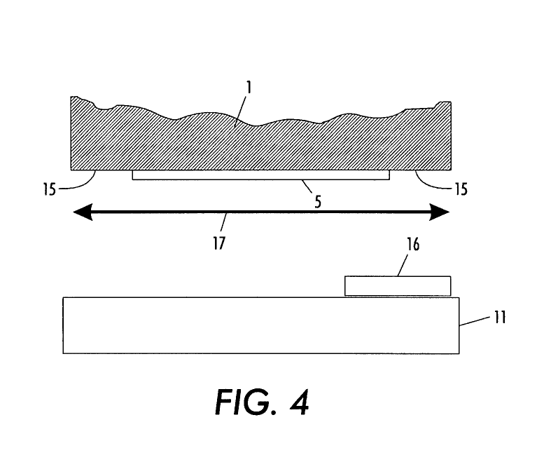

In FIG. 4 a photoreceptor (PR) surface (belt or drum) 1 is shown in spaced relationship to corona housing 11. The PR surface 1 has a paper sheet 5 position thereon leaving an uncovered PR surface(s) 15, i.e. the portion of the PR not protected or covered by sheets. While the drawing of FIG. 4 shows unprotected end portions of the PR 1, any portion of the PR 1 may be protected. The width of sheet 5 is less than the width of PR surface 1 in this embodiment. If this unprotected PR surface 15 is not covered, it is susceptible to receiving charges from the corona charger 11 and during extended exposure, these charges will change the behavior of the PR 1 during subsequent imaging runs. This does not become apparent until the user changes to a paper size that happens to overlap both damaged and protected PR areas. The developed image will appear slightly different in each area because of the damaged PR areas 15.

To prevent this drawback, a protective movable shutter 16 is positioned between the corona 11 and the PR 1; this shutter(s) 16 covers the unprotected PR areas 15 during the charging thereby preventing unwanted charge from hitting these PR surfaces 15.

In FIG. 4 one movable cover 16 is shown to protect an uncovered PR surface(s) 15. Two covers 16 may be used to protect both uncovered PR surfaces 15 shown. Therefore, while for clarity only one cover 16 is shown in FIG. 4, two or more covers may be used when desirable to cover two or more uncovered PR surfaces 15.

Any suitable method or means may be used to move the shutter 16 provided it is automatically moved in relationship to the width of paper sheet 5. The shutter 16 is enabled to move at least a distance along the charge emitting portion of the corona that is defined by the difference of the PR surface 1 width minus the width of the paper 5 being used. The arrows 17 in FIG. 4 define the path over which the shield 5 can travel to protect any uncovered portions of the PR 1, i.e., “exposed portions”.

To summarize, the present embodiments provide a dicorotron unit of an electrostatic marking system which comprises in an operative arrangement with a photoconductive surface, a corona housing, a corona wire or pins positioned inside said housing, and a movable corona cover or shutter enabled to be automatically adjusted over or along the length of said corona housing. The shutter or cover is in an embodiment movably connected to an adjusting rack, or adjuster, the movement of this adjusting rack is determined by a controller in operative communication with said rack. The controller is enabled to determine a width of a sheet being used in the marking system and is enabled to communicate this width to the adjuster. It is enabled to move the shutter cover to a location where it will protect the photoreceptor at any portions not covered by said paper. Also the cover or shutter is adapted to block any electrical charge from passing therethrough. Thus, the cover or shutter is automatically positioned by the controller and adjuster as determined by a width of paper being used. As earlier noted, the present embodiments provide the use of a dynamic shutter device that would act as a shield between the transfer corona and the photoreceptor belt to prevent positive charging of the unprotected (not covered by paper) PR surface.

Another embodiment of the invention provides a corona charging unit used in a transfer station of an electrostatic marking system. This unit comprising in an operative arrangement with a PR surface, a controller, a corona housing, a corona wire located in said housing and extending throughout substantially the length of said housing. The wire is enabled to emit a corona charge through an open portion of said corona housing. An automatically movable inboard cover extends over and closes at least a portion of said open portion of said housing. The cover is in movable connection to an adjuster, the adjuster is movable as determined by the controller and by a motor connected to the controller. The cover is automatically slidably movable to a location that will prevent electrical charge from said wire to contact a photoreceptor in an area where there is no paper adjacent to said photoreceptor. This automatically adjusted cover is enabled to be positioned by said controller after a determination of a width of a paper that will be used in said electrostatic marking system.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A corona charging unit of an electrostatic marking system which comprises in an operative arrangement with a photoconductive surface, a corona housing, a corona wire positioned inside said housing, and a movable corona cover or shutter enabled to be automatically adjusted over at least a portion of the length of said corona housing, said shutter or cover movably connected to an adjuster, an automatically adjusted movement of said adjuster determined by a controller in operative communication with said rack, said movement depending upon a width of paper used in said marking system.

2. The unit of claim 1 wherein said controller is enabled to determine said width of a sheet being used in said electrostatic marking system and to communicate this width to said adjuster.

3. The unit of claim 1 wherein said controller is enabled to determine width of paper being used and enabled to move said shutter or cover to a location where it will protect the photoreceptor at exposed portions not covered by said paper.

4. The unit of claim I wherein said shutter or cover is of a material that is adapted to block any electrical charge from passing there through.

5. The unit of claim 1 wherein said shutter or cover is automatically moved and positioned by said controller and adjuster as determined by a width of paper being used and exposed portions of said photoconductive surface.

6. The unit of claim 1 wherein the automatically movable shutter or cover is adapted to prevent said photoreceptor photoconductive surface from being contacted with transfer corona charge in an area where there is no paper adjacent said photoreceptor.

7. The unit of claim 1 wherein said controller is linked to a motor and adjuster to automatically change positioning of said corotron cover as determined by different widths of paper being used in said system.

8. A corona unit useful in a transfer station of an electrostatic marking system with a said unit comprising in an operative arrangement with a photoconductive surface a controller, a corona housing, a corona wire positioned inside said housing, and an automatically movable corotron cover or shutter enabled to be automatically adjusted along a length of said housing, said cover movably connected to an adjuster, said adjuster enabled to automatically move said cover to any position along a length of said wire and enabled to act as a shield between said corona housing and said photoconductive surface as determined by said controller, said controller in operative communication with a motor and said adjuster, said controller enabled to match said movement or position to a width of paper being used in said system and exposed portions of said photoconductive surface.

9. The unit of claim 8 wherein said controller is enabled to determine a width of a sheet being used in said marking system and to communicate this width to said adjuster.

10. The unit of claim 8 wherein said controller is enabled to automatically determine the width of paper being used and enabled to move said shutter or cover to a location between said photoconductive surface and said corona housing where it will protect the photoreceptor at portions not covered by said paper.

11. The unit of claim 8 wherein said shutter or cover is adapted to block any electrical charge from passing there through.

12. The unit of claim 8 wherein said shutter or cover is automatically positioned between said photoconductive surface and said corona housing by said controller and adjuster as determined by a width of paper being used and exposed portions of said photoconductive surface.

13. The unit of claim 8 wherein the automatically movable shutter or cover is adapted to prevent said photoconductive surface from being contacted with transfer corona charge in an area where there is no paper adjacent said photoreceptor or surface.

14. A corona charging unit used in a transfer station of an electrostatic marking system, said transfer station positioned along a path of a photoconductive surface, said unit comprising in an operative arrangement with said photoconductive surface, a controller, a corona housing, a corona wire located in said housing and extending throughout substantially the length of said housing, said wire enabled to emit a corona charge through an open portion of said corona housing, said open portion being adjacent said photoconductive surface and an automatically movable cover or shutter extending over and closing at least a portion of said open portion of said housing, said cover or shutter enabled to move a distance at least equal to exposed portions of said photoconductive surface, said shutter or cover in movable connection to an adjuster, said adjuster movable as determined by said controller and moved by a motor connected to said controller, said cover automatically slidably movable to a location between said photoconductive surface and said housing that will prevent electrical charge from said wire from contacting said photoconductive surface in areas where there is no paper adjacent to said photoreceptor, said automatically adjusted cover or shutter enabled to be positioned by said controller after a determination of a width of said paper that will be used as an image receiving sheet in said electrostatic marking system.

15. The unit of claim 14 wherein said controller is enabled to automatically calibrate a width of a sheet being used in said marking system and to communicate this width to said adjuster.

16. The unit of claim 14 wherein said controller is enabled to determine the width of paper being used and enabled to move said cover to a location where it will protect the photoconductive surface from being contacted with transfer corona charge in an exposed area of said photoconductive surface where there is no paper adjacent said surface and wherein said cover or shutter is enabled to travel a distance at least equal to said exposed portions of said photoconductive surface during a charging by said corona.

17. The unit of claim 14 wherein said cover is comprised of a material which is adapted to block any electrical charge from passing there through.

18. The unit of claim 14 wherein said shutter or cover is automatically positioned along the length of said housing by said controller and adjuster as determined by various widths of paper being used in different imaging runs.

19. The unit of claim 14 wherein the automatically movable shutter or cover is photoconductive positioned between said surface and said housing and is adapted to prevent said photoconductive surface from being contacted with transfer corona charge in an area of said photoconductive surface where there is no paper adjacent said surface in exposed portions of said photoconductive surface.

20. The unit of claim 14 wherein said cover or shutter is enabled to move at least a distance equal to a width of said photoconductive surface less a width of a paper adjacent thereto.
